(19) United States
(12) Patent Application Publication
(10) Pub. No.: US 2011/0263806 A1
(43) Pub. Date: Oct. 27, 2011

(54) COPOLYMER FOR PRODUCING MOLDED BODIES THAT ARE DIMENSIONALLY STABLE UNDER HEAT FROM MOLDING COMPOUNDS OR CAST GLASS

(75) Inventors: Gerald Dietrich, Alsbach-Haehnlein (DE); Ruediger Carloff, Darmstadt (DE); Wilhelm Karnbrock, Bensheim (DE); Joachim Knebel, Alsbach-Haehnlein (DE); Zhong Shen, Shanghai (CN); Chiew-Chiang Haw, Taipei (CN)

(73) Assignee: Evonik Roehm GmbH, Darmstadt (DE)

(21) Appl. No.: 13/128,894

(22) PCT Filed: Oct. 15, 2009
(86) PCT No.: PCT/EP2009/063443

§ 371 Date: Jul. 18, 2011

(30) Foreign Application Priority Data
Nov. 14, 2008 (DE) 10 2008 057 438.4

(51) Int. Cl. C08F 220/58; B29C 45/00; B29C 47/00; C08F 232/08

(52) U.S. Cl. 526/281; 526/307.7; 264/328.1; 264/319

(57) ABSTRACT

The invention relates to a copolymer for producing molded compounds or cast glass for the production of molded bodies having increased dimensional stability under heat, obtainable from the copolymerization of A) one or more ethylenically unsaturated ester compounds of the formula (I), where R¹ is hydrogen or methyl and R² a linear or branched alkyl group with 1 to 8 carbon atoms, B) one or more ethylenically unsaturated ester compounds of the formula (II), where R³ is hydrogen or methyl and R⁴ a cyclic group with 8 to 30 carbon atoms, C) one or more ethylenically unsaturated ester compounds of the formula (III), where R⁵ is hydrogen or methyl and R⁶ and R⁷, independently of each other, are hydrogen or a linear or branched group with 1 to 40 carbon atoms.

The present invention relates to a copolymer for the production of heat-resistant moulding compositions or cast transparent sheet.

Polyalkyl methacrylate moulding compositions, in particular polymethyl methacrylate (PMMA) moulding compositions, are frequently used for plastics mouldings or plastics sheet where these have high transparency, excellent optical quality and low water absorption. The heat resistance of the said moulding compositions is comparatively low. For PMMA moulding compositions it is, defined by way of the Vicat point, from 105 to 114° C., as a function of polymerization temperature.

PMMA moulding compositions are frequently polymerized in the presence of acrylates. The acrylates cause a change in flow properties, thus leading to an increase in the thermal stability of the PMMA and to easier processing. However, they have the disadvantage of causing a further fall in heat resistance.

There are therefore restrictions on the field of application possible for polyalkyl methacrylate moulding compositions, in particular PMMA moulding compositions. The “service temperature” here is markedly below the softening point, the result being that, in the case of PMMA for example, any temperature greater than 95° C. can be assumed to cause defective serviceability of the polymer.

Other plastics therefore have to be used for applications at higher temperatures.

Examples of transparent plastics that can be used here are polycarbonates with Vicat point of about 150° C., but here again the service temperature of polycarbonate does not extend as far as the Vicat point of the material, 150° C., but is lower by about 20° C., therefore being about 130° C. Polycarbonate is much more susceptible to scratching than PMMA and much less weathering-resistant.

A known alternative reduces the freedom of motion of the polymer chains by copolymerizing MMA with bulky comonomers. The result of this effect is an increase in the heat resistance of the PMMA.

It is also known that methacrylamides as comonomer in the polymerization reaction using methacrylates lead to an increase in heat resistance.

By way of example, the publication CN 1314423 A proposes copolymerizing methyl methacrylate with N-monosubstituted methacrylamides, e.g. N-isobornylmethacrylamide. The glass transition point of the resultant copolymer is said to be in the range from 120° C. to 123° C.

Similarly, the publication EP 1767376 A1 describes organic particles for ink-jet media, comprising a copolymer composed of an alicyclic (meth)acrylate having from 7 to 19 carbon atoms in the ester group and a copolymerizable monomer.

Isobornyl methacrylate is mentioned as preferred alicyclic (meth)acrylate having from 7 to 19 carbon atoms in the ester group.

Examples of copolymerizable monomer mentioned are methyl methacrylate, N-aminoalkylacrylamides and N-aminoalkylmethacrylamides. It is also pointed out that the compounds mentioned can be selected alone or in combinations of two or more as copolymerizable monomer.

For the purposes of one particular variant, blends of two copolymers are used, and the first copolymer here can, for example, comprise units of methyl methacrylate and of isobornyl methacrylate while the second copolymer can comprise, for example, units of methyl methacrylate and of methacrylamide.

Although these approaches to a solution are in principle a suitable method of increasing the heat resistance of PMMA moulding compositions, they nevertheless have a number of disadvantages. Firstly, the use of (meth)acrylamides markedly increases the water absorption of the resultant copolymer. Furthermore, because of the nitrogen group of the methacrylamide, the yellowness index of the copolymers is markedly higher than that of straight methyl (meth)acrylate. Finally, the comonomers needed are also comparatively expensive.

JP2008-024843 A discloses an acrylamide-cyclohexyl methacrylate-2-ethylhexyl acrylate-glycidyl methacrylate-methacrylic acid-methyl methacrylate copolymer.

EP 716344 A1 describes a benzyl methacrylate-N-(p-hydroxyphenyl)methacrylamide-acrylonitrile-methyl methacrylate-methacrylic acid copolymer.

It was therefore an object of the present invention to indicate better ways of increasing the heat resistance of polyalkyl (meth)acrylate moulding compositions, in particular of PMMA moulding compositions. The intention was to cite a polymeric starting material which is at least equivalent in terms of the favourable properties of polyalkyl (meth)acrylate (transparency, weathering resistance, processability) but which is superior thereto in terms of heat resistance. The novel plastics material should moreover be suitable for the production of mouldings by the casting process, or for processing in plastics moulding compositions which can be used to manufacture mouldings with increased heat resistance, in the injection-moulding and/or extrusion process. The moulding compositions were moreover intended to have comparatively low water absorption and to be relatively resistant to discoloration.

A copolymer with all of the features of Claim 1 achieves these objects, and also achieves other objects not individually listed. Particularly advantageous embodiments of the copolymer are described in the dependent claims. The remaining claims protect a heat-resistant cast transparent sheet product, the use of the copolymer in moulding compositions, a heat-resistant moulding comprising a copolymer of the invention, and its use.

Surprisingly, it has been found that heat resistance increases particularly markedly when short-chain alkyl (meth)acrylates, e.g. methyl methacrylate, are copolymerized with (meth)acrylamides and with cyclic (meth)acrylates. The increase in heat resistance in the terpolymer is significantly more marked than would be expected on the basis of the glass transition point of the individual copolymers.

Provision of a copolymer obtainable by copolymerization of
A) one or more ethylenically unsaturated ester compounds of the formula (I)

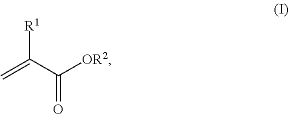

in which R¹ is hydrogen or methyl and R² is a linear or branched alkyl moiety having from 1 to 8 carbon atoms,
B) one or more ethylenically unsaturated ester compounds of the formula (II)

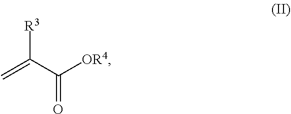

in which R³ is hydrogen or methyl and R⁴ is a cyclic moiety having from 8 to 30 carbon atoms,
C) one or more ethylenically unsaturated amide compounds of the formula (III)

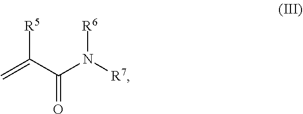

in which R⁵ is hydrogen or methyl and R⁶ and R⁷, respectively independently of one another, are hydrogen or a linear or branched moiety having from 1 to 40 carbon atoms,
   provides a comparatively simple but not readily foreseeable method for achieving a significant improvement in the heat resistance of polyalkyl (meth)acrylate moulding compositions.

This copolymer, thus obtainable, has a significantly improved property profile. Firstly, it is at least equivalent to polyalkyl (meth)acrylate in terms of its favourable properties (transparency, weathering resistance, processability), and secondly it has significantly higher heat resistance. It is particularly suitable for the production of mouldings in the casting process, or for processing in plastics moulding compositions which can be used to manufacture mouldings with increased heat resistance, in the injection-moulding and/or extrusion process. In comparison with blends, the amount of (meth)acrylamides needed in the combination of components B) and C) in a copolymer in order to achieve a desired heat resistance is less, and the moulding compositions therefore have comparatively low water absorption and have significantly higher colourfastness.

For the purposes of the present invention, it has proved particularly successful to select the moieties R¹, R³ and R⁵ to be identical. For the purposes of one first particularly preferred embodiment, therefore, R¹, R³ and R⁵ are methyl. For the purposes of a second particularly preferred embodiment, R¹, R³ and R⁵ are hydrogen.

R² of the ester compounds of the formula (I) is a linear or branched alkyl moiety having from 1 to 8 carbon atoms, particularly preferably having from 1 to 4 carbon atoms, in particular methyl.

Examples of ester compounds of the formula (I) are (meth)acrylates derived from saturated alcohols, e.g. methyl (meth)acrylate, ethyl (meth)acrylate, n-propyl (meth)acrylate, isopropyl (meth)acrylate, n-butyl (meth)acrylate, tert-butyl (meth)acrylate, pentyl (meth)acrylate, hexyl (meth)acrylate, heptyl (meth)acrylate and octyl (meth)acrylate.

R⁴ of the ester compounds of the formula (II) is a cyclic moiety having from 8 to 30 carbon atoms, preferably an alicyclic hydrocarbon moiety, which is preferably at least bicyclic.

Examples of ester compounds of the formula (II) are 1-naphthyl (meth)acrylate, 2-naphthyl (meth)acrylate, 1-decalin (meth)acrylate, 2-decalin (meth)acrylate, 3-decalin (meth)acrylate, 2,4,5-tri-tert-butyl-3-vinylcyclohexyl (meth)acrylate, 2,3,4,5-tetra-tert-butylcyclohexyl (meth)acrylate, bornyl (meth)acrylate, isobornyl (meth)acrylate and adamantyl (meth)acrylate.

Isobornyl (meth)acrylate is particularly preferably used for the purposes of the present invention.

R⁶ and R⁷ of the amide compounds of the formula (III) are, respectively independently of one another, hydrogen or a linear or branched moiety, preferably an aliphatic moiety, having from 1 to 40 carbon atoms, particularly preferably having from 1 to 20 carbon atoms, in particular having from 1 to 8 carbon atoms.

For the purposes of a first preferred embodiment of the present invention, R⁶ and R⁷ are identical, being particularly preferably hydrogen.

For the purposes of a second preferred embodiment of the present invention, R⁶ is hydrogen and R⁷ is a hydrocarbon moiety having from 1 to 20 carbon atoms, particularly preferably having from 1 to 8 carbon atoms, in particular having from 1 to 4 carbon atoms.

Examples of amide compounds of the formula (III) are (meth)acrylamide, methyl(meth)acrylamide, dimethyl(meth)acrylamide, ethyl(meth)acrylamide, diethyl(meth)acrylamide, n-propyl(meth)acrylamide, di-n-propyl(meth)acrylamide, isopropyl(meth)acrylamide, diisopropyl(meth)acrylamide, n-butyl(meth)acrylamide, di-n-butyl(meth)acrylamide, sec-butyl(meth)acrylamide, di-sec-butyl(meth)acrylamide, tert-butyl(meth)acrylamide, di-tert-butyl(meth)acrylamide, benzyl(meth)acrylamide, N-(3-dimethylaminopropyl)(meth)acrylamide, hexyl(meth)acrylamide and dihexyl(meth)acrylamide.

Isopropyl(meth)acrylamide is particularly preferably used for the purposes of the present invention.

The relative proportions of the comonomer units in the copolymer according to the invention are relatively unimportant. However, they can be utilized in order to influence the property profile of the copolymer in a controlled manner. In this connection, copolymers which have proved particularly successful are those obtainable by copolymerization of
A) from 40.0% by weight to 92.0% by weight of one or more ethylenically unsaturated ester compounds of the formula (I),
B) from 4.0% by weight to 30.0% by weight of one or more ethylenically unsaturated ester compounds of the formula (II) and
C) from 4.0% by weight to 30.0% by weight of one or more ethylenically unsaturated amide compounds of the formula (III),
   where the proportions of components A), B) and C) are based on the weight of the monomer composition and preferably give a total of 100.0% by weight.

The copolymer of the present invention can, if appropriate, comprise further repeat units which derive from other ethylenically unsaturated monomers capable of copolymerization with the compounds of the formulae (I) and/or (II) and/or (III). The proportion of the comonomers is preferably in the range from 0 to 40% by weight, in particular from 1 to 35% by weight and particularly preferably from 5 to 30% by weight, based on the weight of the monomer compositions for producing the copolymer of the invention.

Particularly suitable comonomers here for the polymerization reaction according to the present invention correspond to the formula (IV)

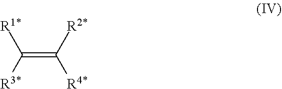

in which R¹* and R²* have been independently selected from the group consisting of hydrogen, halogens, CN, linear or branched alkyl groups having from 1 to 20, preferably from 1 to 6, and particularly preferably from 1 to 4, carbon atoms, which can have from 1 to (2n+1) halogen atoms as substituents, where n is the number of carbon atoms of the alkyl group (an example being CF₃), α,β-unsaturated linear or branched alkenyl or alkynyl groups having from 2 to 10, preferably from 2 to 6, and particularly preferably from 2 to 4, carbon atoms, which can have from 1 to (2n−1) halogen atoms, preferably chlorine, as substituents, where n is the number of carbon atoms of the alkyl group, an example being CH₂═CCl—, cycloalkyl groups having from 3 to 8 carbon atoms, which can have from 1 to (2n−1) halogen atoms, preferably chlorine, as substituents, where n is the number of carbon atoms of the cycloalkyl group; aryl groups having from 6 to 24 carbon atoms, which can have from 1 to (2n−1) halogen atoms, preferably chlorine, and/or alkyl groups having from 1 to 6 carbon atoms, as substituents, where n is the number of carbon atoms of the aryl group; C(═Y*)R⁵*, C(═Y*)NR⁶*R⁷*, Y*C(═Y*)R⁵*, SOR⁵*, SO₂R⁵*, OSO₂R⁵*, NR⁸*SO₂R⁵*, PR⁵*₂, P(═Y*)R⁵*₂, Y*PR⁵*₂, Y*P(═Y*)R⁵*₂, NR⁸*₂, where these can have been quaternized with an additional R⁸* group, aryl group or heterocyclyl group, where Y* can be NR^{B}*, S or O, preferably O; R⁵* is an alkyl group having from 1 to 20 carbon atoms, alkylthio having from 1 to 20 carbon atoms, OR¹⁵ (where R¹⁵ is hydrogen or an alkali metal), alkoxy having from 1 to 20 carbon atoms, aryloxy or heterocyclyloxy; R⁶* and R⁷* are independently hydrogen or an alkyl group having from 1 to 20 carbon atoms, or R⁶* and R⁷* can together form an alkylene group having from 2 to 7, preferably from 2 to 5, carbon atoms, where they form a 3- to 8-membered, preferably 3- to 6-membered, ring, and R⁸* is hydrogen or linear or branched alkyl or aryl groups having from 1 to 20 carbon atoms;
R³* and R⁴* are independently selected from the group consisting of hydrogen, halogen (preferably fluorine or chlorine), alkyl groups having from 1 to 6 carbon atoms and COOR⁹*, in which R⁹* is hydrogen, an alkali metal or an alkyl group having from 1 to 40 carbon atoms, or R³* and R⁴* together can form a group of the formula (CH₂)_{n′}, which can have from 1 to 2n′ halogen atoms or C₁-C₄-alkyl groups as substituents, or of the formula C(═O)—Y*—C(═O), where n′ is from 2 to 6, preferably 3 or 4, and Y* is defined as above; and where at least 2 of the moieties R¹*, R²*, R³* and R⁴* are hydrogen or halogen.

Among the preferred comonomers are vinyl halides, such as

vinyl chloride, vinyl fluoride, vinylidene chloride and vinylidene fluoride;
vinyl esters, such as vinyl acetate;
styrene, substituted styrenes having an alkyl substituent in the side chain, e.g. α-methylstyrene and α-ethylstyrene, substituted styrenes having an alkyl substituent on the ring, e.g. vinyltoluene and p-methylstyrene, halogenated styrenes, e.g. monochlorostyrenes, dichlorostyrenes, tribromostyrenes and tetrabromostyrenes;
heterocyclic vinyl compounds, e.g. 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinyloxazoles, and hydrogenated vinyloxazoles;
vinyl and isoprenyl ethers;
maleic acid and maleic acid derivatives, e.g. maleic anhydride, methyl maleic anhydride, maleimide, methylmaleimide;
fumaric acid and fumaric acid derivatives;
acrylic acid and methacrylic acid;
dienes, such as divinylbenzene;
aryl (meth)acrylates, e.g. benzyl methacrylate or phenyl methacrylate, where the aryl moieties can respectively be unsubstituted or have up to four substituents;
methacrylates of halogenated alcohols, e.g. 2,3-dibromopropyl methacrylate, 4-bromophenyl methacrylate, 1,3-dichloro-2-propyl methacrylate, 2-bromoethyl methacrylate, 2-iodoethyl methacrylate, chloromethyl methacrylate;
hydroxyalkyl (meth)acrylates, e.g. 3-hydroxypropyl methacrylate, 3,4-dihydroxybutyl methacrylate, 2-hydroxyethyl methacrylate, 2-hydroxypropyl methacrylate, 2,5-dimethyl-1,6-hexanediol(meth)acrylate, 1,10-decanediol(meth)acrylate;
carbonyl-containing methacrylates, e.g. 2-carboxyethyl methacrylate, carboxymethyl methacrylate, oxazolidinylethyl methacrylate, N-(methacryloyloxy)formamide, acetonyl methacrylate, N-methacryloylmorpholine, N-methacryloyl-2-pyrrolidinone, N-(2-methacryloyloxyethyl)-2-pyrrolidinone, N-(3-methacryloyloxypropyl)-2-pyrrolidinone, N-(2-methacryloyloxypentadecyl)-2-pyrrolidinone, N-(3-methacryloyloxyheptadecyl)-2-pyrrolidinone;
glycol dimethacrylates, e.g. 4-butanediol methacrylate, 2-butoxyethyl methacrylate, 2-ethoxyethoxymethyl methacrylate, 2-ethoxyethyl methacrylate;
methacrylates of ether alcohols, e.g. tetrahydrofurfuryl methacrylate, vinyloxyethoxyethyl methacrylate, methoxyethoxyethyl methacrylate, 1-butoxypropyl methacrylate, 1-methyl-(2-vinyloxy)ethyl methacrylate, cyclohexyloxymethyl methacrylate, methoxymethoxyethyl methacrylate, benzyloxymethyl methacrylate, furfuryl methacrylate, 2-butoxyethyl methacrylate, 2-ethoxyethoxymethyl methacrylate, 2-ethoxyethyl methacrylate, allyloxymethyl methacrylate, 1-ethoxybutyl methacrylate, methoxymethyl methacrylate, 1-ethoxyethyl methacrylate, ethoxymethyl methacrylate and ethoxylated (meth)acrylates, these preferably having from 1 to 20, in particular from 2 to 8, ethoxy groups;
aminoalkyl (meth)acrylates, e.g. dimethylaminopropyl methacrylate, 3-diethylaminopentyl methacrylate, 3-d ibutylaminohexadecyl (meth)acrylate;
nitriles of (meth)acrylic acid;
other nitrogen-containing methacrylates, e.g. N-(methacryloyloxyethyl)diisobutyl ketimine, N-(methacryloyloxyethyl)dihexadecyl ketimine, methacryloylamidoacetonitrile, 2-methacryloyloxyethylmethylcyanamide, cyanomethyl methacrylate; heterocyclic (meth)acrylates, e.g. 2-(1-imidazolyl)ethyl (meth)acrylate, 2-(4-morpholinyl)ethyl (meth)acrylate and 1-(2-methacryloyloxyethyl)-2-pyrrolidone;
oxiranyl methacrylates, e.g. 2,3-epoxybutyl methacrylate, 3,4-epoxybutyl methacrylate, 10,11-epoxyundecyl methacrylate, 2,3-epoxycyclohexyl methacrylate, 10,11-epoxyhexadecyl methacrylate; glycidyl methacrylate.

These monomers can be used individually or in the form of a mixture.

The polymerization to obtain the copolymers can take place in a manner known per se. Processes of free-radical polymerization have proved particularly successful, particularly bulk polymerization, polymerization in a solvent, suspension polymerization and emulsion polymerization, generally using a polymerization initiator and a chain-transfer agent.

Among the initiators that can be used are the azo initiators well known to persons skilled in the art, e.g. AlBN and 1,1-azobiscyclohexanecarbonitrile, and also peroxy compounds, e.g. methyl ethyl ketone peroxide, acetylacetone peroxide, dilauroyl peroxide, tert-butyl 2-ethylperhexanoate, ketone peroxide, tert-butyl peroctoate, methyl isobutyl ketone peroxide, cyclohexanone peroxide, dibenzoyl peroxide, tert-butyl peroxybenzoate, tert-butylperoxy isopropyl carbonate, 2,5-bis(2-ethylhexanoylperoxy)-2,5-dimethylhexane, tert-butyl 2-ethylperoxyhexanoate, tert-butyl 3,5,5-trimethylperoxyhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, mixtures of two or more of the abovementioned compounds with one another, and mixtures of the abovementioned compounds with compounds not mentioned but likewise capable of forming free radicals.

Suitable chain-transfer agents are sulphur-free and sulphur-containing compounds which are known per se. Among the sulphur-free compounds are, by way of example, and without any intended resultant restriction, dimeric α-methylstyrene (2,4-diphenyl-4-methyl-1-pentene), enol ethers of aliphatic and/or cycloaliphatic aldehydes, terpenes, α-terpines, terpinols, 1,4-cyclohexadiene, 1,4-dihydronaphthalene, 1,4,5,8-tetrahydronaphthalene, 2,5-dihydrofuran, 2,5-dimethylfuran and/or 3,6-dihydro-2H-pyran, preference being given to dimeric α-methylstyrene.

Among the sulphur-containing compounds are, for example, and without any intended resultant restriction, thioglycolic acid, 2-mercaptoethanol, 2-ethylhexyl thioglycolate, n-butyl mercaptan, octyl mercaptan, n-dodecyl mercaptan, tert-dodecyl mercaptan, methyl 3-mercaptopropionate.

These chain-transfer agents are commercially available. However, they can also be prepared in a manner known to a person skilled in the art. By way of example, the Patent DE 966 375 describes the preparation of dimeric α-methylstyrene. Enol ethers of aliphatic and/or of cycloaliphatic aldehydes are disclosed in the Patent DE 3 030 373. EP 80 405 explains the preparation of terpenes. The laid-open specifications JP 78/121 891 and JP 78/121 890 explain the preparation of α-terpines, terpinols, 1,4-cyclohexadiene, 1,4-dihydronaphthalene, 1,4,5,8-tetrahydronaphthalene. The laid-open specification DE 2 502 283 describes the preparation of 2,5-dihydrofuran, 2,5-dimethylfuran and 3,6-dihydro-2H-pyran.

The monomers can be polymerized at atmospheric pressure, or at subatmospheric or superatmospheric pressure. The polymerization temperature is also non-critical. However, it is generally in the range from −20° C. to 200° C., preferably from 0° C. to 160° C. and particularly preferably from 70° C. to 130° C.

The polymerization reaction can also be carried out in a solvent or without solvent. The term solvent is to be interpreted widely here.

Further information on free-radical polymerization can be found in the technical literature, for example in Ullmann's Encyclopedia of Industrial Chemistry, Sixth Edition. Useful information on bulk polymerization can be found by way of example in Houben-Weyl Vol. E20, Part 2 (1987), page 1145 ff. Useful information on suspension polymerization is also given in the publication Houben-Weyl, Vol. E20, Part 2 (1987), page 1149 ff.

Alongside the constitution of the copolymer, its molecular weight can also have some significance for the subsequent processing of the copolymers for the production of heat-resistant mouldings. By way of example, controlled adjustment of molecular weight can be advantageous for some types of possible subsequent processing.

One possibility within the scope of the invention, in the actual copolymerization process, is to set molecular weights sufficiently high as to prevent any downstream thermal moulding process. Another possibility is to select a relatively low molecular weight so as to obtain a copolymer which can undergo downstream moulding in further thermal processes.

Specifically, if the intention is that the comonomers of the invention be processed by extrusion or injection moulding, a relatively low molar mass M_{w} is then preferred for the copolymers of the invention, from 30 000 g/mol to 250 000 g/mol, advantageously from 60 000 g/mol to 200 000 g/mol. Copolymers of this type can in principle be converted by heating into a thermoplastically processable melt.

The molecular weight can be determined by known methods. By way of example, gel permeation chromatography (GPC) can be used. Another method that can be used to determine the molecular weights is osmometry, for example “vapour phase osmometry”. The methods mentioned are described by way of example in: P. J. Flory, “Principles of Polymer Chemistry” Cornell University Press (1953), Chapter VII, 266-316, and “Macromolecules, an Introduction to Polymer Science”, F. A. Bovey and F. H. Winslow, Editors, Academic Press (1979), 296-312, and W. W. Yau, J. J. Kirkland and D. D. Bly, “Modern Size Exclusion Liquid Chromatography”, John Wiley and Sons, New York, 1979. Gel permeation chromatography is preferred for determining the molecular weights of the polymers presented herein. The standards used should preferably be polymethacrylate or polyacrylate standards.

The copolymers of the present invention can in principle be adapted to any of the shaping processes familiar to a person skilled in the art, for the production of mouldings with improved heat resistance.

Copolymers according to the invention can be processed advantageously to give plastics moulding compositions in pellet form. These moulding-composition pellets are then particularly suitable for further processing by extrusion or injection moulding. The moulding-composition pellets are produced, for example, by extrusion and pelletization of the plastics which have been produced in the form of polymer syrup or in the form of beads, while removing low-molecular-weight minor constituents from the polymers through devolatilization in the extruder. This type of process is described by way of example in Handbuch der Kunststoff-Extrusionstechnik [Handbook of Plastics Extrusion Technology], Vol. I and II (Eds.: F. Heusen, W. Kappe, H. Potente; Hauser Verlag 1986 and 1989).

If the actual polymerization procedure has set a molecular weight which is sufficiently high that further downstream thermal processing is difficult, care has to be taken according to the invention that the moulding process takes place, preferably in a suitable mould, before the polymerization procedure is complete.

In one preferred embodiment according to the invention, the copolymer of the invention is produced by polymerization in solution, e.g. in a solvent or in the monomers themselves, and, as a function of the intended use of the polymer syrup, is devolatilized. The suspension polymerization, too, is a very accessible route to production of the copolymer. It is equally possible to produce the polymer in the form of cast transparent sheets. In the production of cast transparent sheet, a polymer syrup is polymerized between one or two metal and, respectively, glass plates.

The invention also accordingly provides particularly heat-resistant moulding compositions, comprising
A) one or more ethylenically unsaturated ester compounds of the formula (I)

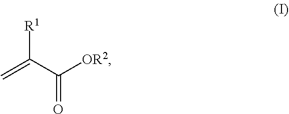

in which R¹ is hydrogen or methyl and R² is a linear or branched alkyl moiety having from 1 to 8 carbon atoms,
B) one or more ethylenically unsaturated ester compounds of the formula (II)

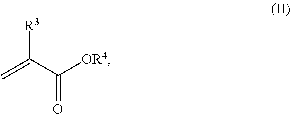

in which R³ is hydrogen or methyl and R⁴ is a cyclic moiety having from 8 to 30 carbon atoms,
C) one or more ethylenically unsaturated amide compounds of the formula (III)

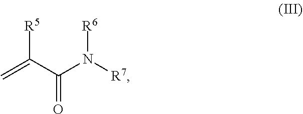

in which R⁵ is hydrogen or methyl and R⁶ and R⁷, respectively independently of one another, are hydrogen or a linear or branched moiety having from 1 to 40 carbon atoms.

In one preferred embodiment, the moulding composition takes the form of cast transparent sheet product, preferably having an average molar mass M_{W} in the range from 500 000 g/mol to 5 000 000 g/mol.

The mouldings thus obtainable preferably feature the following properties:

The viscosity number of the moulding is preferably in the range from 30 ml/g to 90 ml/g, measured to ISO 1628-6.

The Vicat point of the moulding is preferably above 112° C., in particular above 115° C., measured to ISO 306.

The mouldings according to the invention can in particular be used as parts of household devices, of communication devices, of hobby equipment or of sports equipment, or as bodywork parts or parts of bodywork parts in automobile construction, shipbuilding or aircraft construction, or as parts for illuminants, signs or symbols, retail outlets or cosmetics counters, containers, household-decoration items or office-decoration items, furniture applications, shower doors and office doors, or else as parts, in particular sheets, in the construction industry, or as a walls, in particular sound-deadening walls, or as window frames, bench seats, lamp covers, diffuser sheets, or LED lenses, LED bodies, or LED semiconductor cover, or in solar modules, or in automobile headlights as lens, reflector, holder or cover, or sensor covers, and/or for automobile glazing. Examples of typical exterior automobile parts are spoilers, panels, roof modules or exterior-mirror housings.

The invention is explained in more detail below, using examples, without any intended resultant restriction of the concepts underlying the invention.

List of abbreviations used for substances in the inventive examples and comparative examples:
MMA: Methyl methacrylate
MAA: Methacrylamide
IBOMA: Isobornyl methacrylate
NIPMA: N-Isopropylmethacrylamide
TBPND: tert-butyl peroxyneodecanoate
TBPEH: tert-butyl 2-ethylperoxyhexanoate
DDM: n-dodecyl mercaptan
MMP: methyl 3-mercaptopropionate

Unless other details are given, percentages and parts are always percentages by weight and parts by weight.

The following analytical methods were used to determine the properties used for characterization of the polymers in the text examples and tables below, which show a summary of the conditions for the copolymerization reaction:
MiniVicat to ISO 306
Viscosity number to ISO 1628-6
Thermostability by means of thermal gravimetric measurements (2% weight loss, heating rate 5 K/min; nitrogen atmosphere)

### 1) Production of an MMA/IBOMA Copolymer

80% of the monomers and n-dodecyl mercaptan were used as initial charge in a stirred reactor. Polymerization was carried out for 300 min at 80° C. in the presence of solvent, and during this time the remaining proportion of monomer, tert-butyl peroxyneodecanoate and further solvent were metered in, as stated in Tables 1 and 2. Following the metering process, the reaction was allowed to continue for a further 120 min at 95° C., after addition of tert-butyl 2-ethylperoxyhexanoate. The final conversion was 93%. The polymer was then isolated in a vented extruder, by extracting the solvent at 250° C. and 20 mbar. The viscosity number of the resultant polymer was determined, as were its thermal stability and MiniVicat. Table 3 lists the properties of the product.

### 2) Production of an MMA/MAA Copolymer

All of the monomers and n-dodecylmercaptan were used as initial charge in a stirred reactor. Polymerization was carried out for 360 min at 80° C. in the presence of solvent, and during this time tert-butyl peroxyneodecanoate and further solvent were metered in, as stated in Tables 1 and 2. Following the metering process, the reaction was allowed to continue for a further 120 min at 87° C., after addition of tert-butyl 2-ethylperoxyhexanoate. The final conversion was 99%. The polymer was then isolated in a vented extruder, by extracting the solvent at 270° C. and 20 mbar. The viscosity number of the resultant polymer was determined, as were its thermal stability and MiniVicat. Table 3 lists the properties of the product.

### 3) Production of an MMA/MAA/IBOMA Copolymer

70% of the monomers and methyl 3-mercaptopropionate were used as initial charge in a stirred reactor. Polymerization was carried out for 360 min at 80° C. in the presence of solvent, and during this time the remaining proportion of monomer, tert-butyl peroxyneodecanoate and further solvent were metered in, as stated in Tables 1 and 2. Following the metering process, the reaction was allowed to continue for a further 120 min at 85° C., after addition of tert-butyl 2-ethylperoxyhexanoate. The final conversion was 95%. The polymer was then isolated in a vented extruder, by extracting the solvent at 260° C. and 20 mbar. The viscosity number of the resultant polymer was determined, as were its thermal stability and MiniVicat. Table 3 lists the properties of the product.

### 4) Production of an MMA/NIPMA Copolymer

60% of the monomers and methyl 3-mercaptopropionate were used as initial charge in a stirred reactor. Polymerization was carried out for 360 min at 80° C. in the presence of solvent, and during this time the remaining proportion of monomer, tert-butyl peroxyneodecanoate and further solvent were metered in, as stated in Tables 1 and 2. Following the metering process, the reaction was allowed to continue for a further 120 min at 95° C., after addition of tert-butyl 2-ethylperoxyhexanoate. The final conversion was 89%. The polymer was then isolated in a vented extruder, by extracting the solvent at 270° C. and 20 mbar. The viscosity number of the resultant polymer was determined, as were its thermal stability and MiniVicat. Table 3 lists the properties of the product.

### 5) Production of an MMA/NIPMA/IBOMA Copolymer

60% of the monomers and methyl 3-mercaptopropionate were used as initial charge in a stirred reactor. Polymerization was carried out for 360 min at 80° C. in the presence of solvent, and during this time the remaining proportion of monomer, tert-butyl peroxyneodecanoate and further solvent were metered in, as stated in Tables 1 and 2. Following the metering process, the reaction was allowed to continue for a further 120 min at 95° C., after addition of tert-butyl 2-ethylperoxyhexanoate. The final conversion was 98%. The polymer was then isolated in a vented extruder, by extracting the solvent at 250° C. and 20 mbar. The viscosity number of the resultant polymer was determined, as were its thermal stability and MiniVicat. Table 3 lists the properties of the product.

TABLE 1
Overview of monomer constitutions

| Exp. # | 1 | 2 | 3 | 4 | 5 |
|---|---|---|---|---|---|
| MMA | 85 | 90 | 80 | 85 | 76 |
| MAA | — | 10 | 10 | — | — |
| IBOMA | 15 | — | 10 | — | 12 |
| NIPMA | — | — | — | 15 | 12 |

TABLE 2
Concentrations and auxiliaries

| Exp. # | 1 | 2 | 3 | 4 | 5 |
|---|---|---|---|---|---|
| TBPND | 0.38 | 0.30 | 0.30 | 0.30 | 0.30 |
| TBPEH | 0.05 | 0.10 | 0.10 | 0.10 | 0.10 |
| DDM | 0.40 | 0.30 | — | — | — |
| MMP | — | — | 0.22 | 0.16 | 0.16 |
| n-Butyl acetate [%] | 50 | — | — | 30 | 30 |
| 1-Propanol/water | — | 20 | 20 | — | — |
| 4:1 [%] | | | | | |

TABLE 3
Overview of polymer properties

| Exp. # | 1 | 2 | 3 | 4 | 5 | PMMA |
|---|---|---|---|---|---|---|
| VSP [° C.] | 116 | 132 | 139 | 121 | 129 | 115 |
| V.N. [ml/g] | 53 | 55 | 53 | 63 | 45 | 52 |
| T_{d} [° C.] | 286 | 287 | 286 | 276 | n.d. | n.d. |

### 6) Production of an MMA/NIPMA/IBOMA Blend

For comparison with polymer 5) produced by way of copolymerization, a blend with the same constitution was studied. This was obtained by blending equal proportions of a copolymer composed of MMA and IBOMA (75-25) and one composed of MMA and NIPMA (75-25) in a kneader.

The resultant polymer contrasts with the terpolymer 5) in that its VSP is only 123° C.

1. A copolymer, obtained by a process comprising copolymerizing
A) one or more ethylenically unsaturated ester compounds of the formula (I) 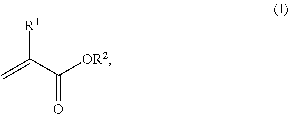
in which R¹ is hydrogen or methyl and R² is a linear or branched alkyl moiety having from 1 to 8 carbon atoms,
B) one or more ethylenically unsaturated ester compounds of the formula (II) 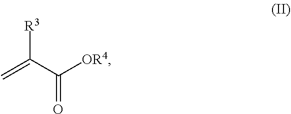
in which R³ is hydrogen or methyl and R⁴ is a cyclic moiety having from 8 to 30 carbon atoms,
C) one or more ethylenically unsaturated amide compounds of the formula (III) 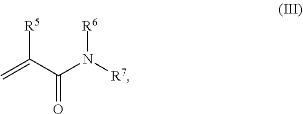
in which R⁵ is hydrogen or methyl and R⁶ and R⁷, respectively independently of one another, are hydrogen or a linear or branched moiety having from 1 to 40 carbon atoms.

2. The copolymer according to claim 1, wherein R¹, R³ and R⁵ are methyl.

3. The copolymer according to claim 1, wherein R¹, R³ and R⁵ are hydrogen.

4. The copolymer according to claim 1, wherein R² is a linear or branched alkyl moiety having from 1 to 4 carbon atoms.

5. The copolymer according to claim 4, wherein R² is methyl.

6. The copolymer according to claim 1, wherein R⁴ is an alicyclic hydrocarbon moiety.

7. The copolymer according to claim 6, wherein R⁴ is an at least bicyclic moiety.

8. The copolymer according to claim 7, wherein R⁴ is isobornyl.

9. The copolymer according to claim 1, wherein R⁶ and R⁷ are hydrogen.

10. The copolymer according to claim 1, wherein R⁶ is hydrogen and R⁷ is a hydrocarbon moiety having from 1 to 20 carbon atoms.

11. The copolymer according to claim 10, wherein R⁷ is a hydrocarbon moiety having from 1 to 4 carbon atoms.

12. The copolymer according to claim 11, wherein R⁷ is isopropyl.

13. The copolymer according to claim 1, obtained by a process comprising copolymerizing
A) from 40.0% by weight to 92.0% by weight of one or more ethylenically unsaturated ester compounds of the formula (I),
B) from 4.0% by weight to 30.0% by weight of one or more ethylenically unsaturated ester compounds of the formula (II) and
C) from 4.0% by weight to 30.0% by weight of one or more ethylenically unsaturated ester compounds of the formula (III).

14. A heat-resistant moulding composition or cast transparent sheet product, comprising
A) one or more ethylenically unsaturated ester compounds of the formula (I) 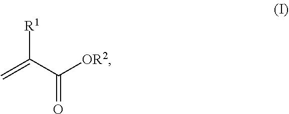
in which R¹ is hydrogen or methyl and R² is a linear or branched alkyl moiety having from 1 to 8 carbon atoms,
B) one or more ethylenically unsaturated ester compounds of the formula (II) 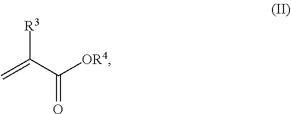
in which R³ is hydrogen or methyl and R⁴ is a cyclic moiety having from 8 to 30 carbon atoms,
C) one or more ethylenically unsaturated amide compounds of the formula (III) 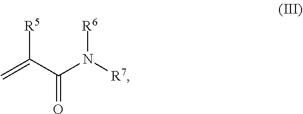
in which R⁵ is hydrogen or methyl and R⁶ and R⁷, respectively independently of one another, are hydrogen or a linear or branched moiety having from 1 to 40 carbon atoms.

15. The moulding composition according to claim 14, having a weight-average molar mass M_{W} is from 30 000 g/mol to 250 000 g/mol.

16. The cast transparent sheet product according to claim 14, having a weight-average molar mass M_{W} in the range from 500 000 g/mol to 5 000 000 g/mol.

17. The copolymer according to claim 1, having a weight-average molar mass M_{W} in the range from 30 000 g/mol to 250 000 g/mol.

18. A method of producing a moulding composition comprising moulding the copolymer according to claim 17 by the extrusion or injection-moulding process.

19. A heat-resistant moulding, comprising a copolymer according to claim 1.

20. The moulding according to claim 19, having a viscosity number, measured to ISO 1628-6, in the range from 30 ml/g to 90 ml/g.

21. The moulding according to claim 19, having a Vicat point, measured to ISO 306, above 112° C.

22. (canceled)
